(19) United States
(12) Patent Application Publication
(10) Pub. No.: US 2026/0114446 A1
(43) Pub. Date: Apr. 30, 2026

(54) Compositions, Methods and Devices for Control and Monitoring Insects

(71) Applicants: Agriculture Victoria Services Pty Ltd, Bundoora (AU); Horticulture Innovation Australia Limited, North Sydney (AU)

(72) Inventors: Kevin Roland Robert Farnier, Brisbane (AU); John Paul Cunningham, Bundoora (AU); David Madge, Bundoora (AU)

(73) Assignees: Agriculture Victoria Services Pty Ltd, Bundoora (AU); Horticulture Innovation Australia Limited, North Sydney (AU)

(21) Appl. No.: 19/429,957

(22) Filed: Dec. 22, 2025

Related U.S. Application Data
(63) Continuation of application No. PCT/AU2024/050693, filed on Jun. 28, 2024.

(30) Foreign Application Priority Data
Jun. 30, 2023 (AU) 2023902105
Dec. 15, 2023 (AU) 2023904089

(51) Int. Cl. A01N 27/00; A01M 1/02; A01M 1/10; A01N 35/02; A01N 43/60; A01P 19/00

(52) U.S. Cl. CPC A01N 27/00; A01M 1/02; A01M 1/103; A01N 35/02; A01N 43/60; A01P 19/00; A01M 2200/011

(57) ABSTRACT

The present invention provides a composition for attracting Carpophilus truncatus beetles, wherein the composition preferably includes one or more pheromone compounds produced by a male beetle of the species Carpophilus truncatus. The present invention also relates to kits, methods and apparatus for attracting, trapping and monitoring for Carpophilus truncatus beetles.

### FIELD OF THE INVENTION

The present invention relates to devices, compositions, and methods for insect control, more particularly the present invention relates to multicomponent compositions used in combination with apparatus for releasing said composition, and devices employing said composition for attracting, trapping and/or monitoring insects, more particularly Carpophilus truncatus beetles.

### BACKGROUND OF THE INVENTION

Carpophilus truncatus is a major pest of almonds, causing significant damage to developing kernels. Current “Attract and Kill” strategies to control this pest rely on a lure composed of (i) beetle aggregation pheromone (produced by adult males of stone fruit attacking Carpophilus beetles) combined with (ii) a microbe-derived synthetic food attractant.

Carpophilus truncatus has also recently been identified as a pest in other nuts including walnuts and pistachio nuts.

Pheromones and analogues have previously been synthesized and identified in the 1990s for various Carpophilus species; however, the pheromones of Carpophilus truncatus have not been well studied (Bartelt et al. 1990, 1992; Bartelt 2010). Further, existing lures developed to control stone fruit attacking Carpophilus beetles are not as effective against C. truncatus.

Common problems in the development of control strategies for Carpophilus beetles include trap type, trap placement, type of food-related odours, pheromones and formulations used in traps, and lure/attractant longevity, with emission rates of some key attractants dropping off in some instances within a day after lure deployment in the field. Also, targeting of specific beetle species is problematic with generalised compositions not achieving the desired specificity and showing a reduced efficacy in protection of a crop (Bartelt 2010).

As such, there exists a need to overcome, or at least alleviate, one or more of the difficulties or deficiencies associated with the prior art.

### SUMMARY OF THE INVENTION

In one aspect, the present invention provides a composition for attracting Carpophilus truncatus beetles, the composition comprising 3,5,7-trimethyl-2,4,6,8-undecatetraene or a geometric isomer thereof and one or more C₆-C₁₆ aldehydes.

By the term ‘composition’ as used herein is meant a mixture of components which may be in the form of a solid, liquid, gas, vapour, gel or any other suitable phase mixture thereof.

The geometric isomer of 3,5,7-trimethyl-2,4,6,8-undecatetraene may be selected from the group consisting of:
(2E,4E,6E,8E)-3,5,7-trimethyl-2,4,6,8-undecatetraene,
(2E,4E,6E,8Z)-3,5,7-trimethyl-2,4,6,8-undecatetraene,
(2E,4E,6Z,8E)-3,5,7-trimethyl-2,4,6,8-undecatetraene,
(2E,4Z,6E,8E)-3,5,7-trimethyl-2,4,6,8-undecatetraene,
(2Z,4E,6E,8E)-3,5,7-trimethyl-2,4,6,8-undecatetraene,
(2E,4E,6Z,8Z)-3,5,7-trimethyl-2,4,6,8-undecatetraene,
(2E,4Z,6E,8Z)-3,5,7-trimethyl-2,4,6,8-undecatetraene,
(2Z,4E,6E,8Z)-3,5,7-trimethyl-2,4,6,8-undecatetraene,
(2E,4Z,6Z,8E)-3,5,7-trimethyl-2,4,6,8-undecatetraene,
(2Z,4E,6Z,8E)-3,5,7-trimethyl-2,4,6,8-undecatetraene,
(2Z,4Z,6E,8E)-3,5,7-trimethyl-2,4,6,8-undecatetraene,
(2E,4Z,6Z,8Z)-3,5,7-trimethyl-2,4,6,8-undecatetraene,
(2Z,4E,6Z,8Z)-3,5,7-trimethyl-2,4,6,8-undecatetraene,
(2Z,4Z,6E,8Z)-3,5,7-trimethyl-2,4,6,8-undecatetraene,
(2Z,4Z,6Z,8E)-3,5,7-trimethyl-2,4,6,8-undecatetraene,
(2Z,4Z,6Z,8Z)-3,5,7-trimethyl-2,4,6,8-undecatetraene.

In a preferred embodiment, the 3,5,7-trimethyl-2,4,6,8-undecatetraene is (E,E,E,E)-3,5,7-trimethyl-2,4,6,8-undecatetraene.

In some embodiments, the composition does not include (2E,4E,6E,8E)-7-ethyl-3,5-dimethyl-2,4,6,8-decatetraene.

In one embodiment, the one or more C₆-C₁₆ aldehyde is a saturated aldehyde. In another embodiment, the one or more C₆-C₁₆ aldehyde is a straight chain aldehyde. In yet another embodiment, the one or more C₆-C₁₆ aldehyde is a straight chain, saturated aldehyde. In a preferred embodiment, the one or more C₆-C₁₆ aldehyde is selected from hexadecanal, pentadecanal, tetradecanal, tridecanal, dodecanal, undecanal, decanal, nonanal, octanal, heptanal and hexanal, especially tetradecanal, hexanal and nonanal, most especially tetradecanal.

In some embodiments, the ratio of 3,5,7-trimethyl-2,4,6,8-undecatetraene and C₆-C₁₆ aldehyde, especially (E,E,E,E)-3,5,7-trimethyl-2,4,6,8-undecatetraene and tetradecanal, is one that results in emission of a 2:1 to 1:5 ratio of 3,5,7-trimethyl-2,4,6,8-undecatetraene and C₆-C₁₆ aldehyde, especially a 2:1 to 1:2 ratio and more especially about a 1:1 ratio of 3,5,7-trimethyl-2,4,6,8-undecatetraene and C₆-C₁₆ aldehyde. In some embodiments, the ratio of the 3,5,7-trimethyl-2,4,6,8-undecatetraene and C₆-C₁₆ aldehyde in the composition is 2:1 to 1:5, especially 1:1 to 1:4, more especially 1:2 to 1:4 or 1:3 to 1:3.5 and most especially about 1:3.3. Compositions comprising one of these ratios may result in emission of a 1:1 ratio of 3,5,7-trimethyl-2,4,6,8-undecatetraene and C₆-C₁₆ aldehyde.

In one embodiment, the composition as described herein further comprises a dimethyl pyrazine. Accordingly, in one embodiment the present invention provides a composition for attracting Carpophilus truncatus beetles, the composition comprising 3,5,7-trimethyl-2,4,6,8-undecatetraene or a geometric isomer thereof, one or more C₆-C₁₆ aldehydes and a dimethyl pyrazine, wherein the 3,5,7-trimethyl-2,4,6,8-undecatetraene or a geometric isomer thereof, one or more C₆-C₁₆ aldehydes are as defined above. In a preferred embodiment, the dimethyl pyrazine is selected from 2,5-dimethyl pyrazine and 2,6-dimethyl pyrazine.

In a preferred embodiment, the composition as described herein further comprises an antioxidant. Examples of suitable antioxidants include butylated hydroxytoluene (BHT), butylated hydroxyanisol (BHA), tocopherols, ascorbic acid and citric acid. In a particular embodiment, the antioxidant is butylated hydroxytoluene.

In an embodiment, the composition as described herein further comprises a carrier. In some embodiments, the carrier may be a solid, semi-solid, gel or liquid, or a combination thereof. A suitable liquid carrier is a volatile solvent, for example a volatile non-polar solvent that is able to solubilise the components of the composition. In a particular embodiment, the carrier is a non-polar hydrocarbon. Examples of suitable volatile, non-polar hydrocarbons include pentane, hexane, heptane and cyclohexane or mixtures thereof. In a preferred embodiment, the carrier is hexane. In some embodiments, the carrier is used to prepare the composition and load it into the dispenser. In some embodiments, the carrier may be allowed to evaporate from the dispenser, at least in part, before the dispenser is stored or deployed in the trap.

In some embodiments, the composition is prepared in n-hexane with 10 mg/mL of 3,5,7-trimethyl-2,4,6,8-undecatetraene, 5 to 50 mg/mL of C₆-C₁₆ aldehyde and 1 mg/mL antioxidant, especially 10 mg/mL of 3,5,7-trimethyl-2,4,6,8-undecatetraene, 10 to 50, 20 to 40 or 30 to 35 mg/mL of C₆-C₁₆ aldehyde and 1 mg/mL antioxidant. In a particular embodiment, the composition is an n-hexane composition comprising about 10 mg/mL of (E,E,E,E)-3,5,7-trimethyl-2,4,6,8-undecatetraene, about 33.3 mg/mL of tetradecanal and 1 mg/mL BHT.

In a further aspect, the present invention provides a dispenser comprising the composition as described herein. In a preferred embodiment, the dispenser allows sustained release of the composition as described herein.

In some embodiments, the dispenser comprises a septum, such as a rubber septum, resin or inert polymer beads, granules, pellets or strips. In a preferred embodiment, the dispenser comprises a septum.

In a further aspect, the present invention provides an apparatus comprising a composition and/or a dispenser as described herein, and a housing for attracting Carpophilus truncatus beetles.

By the term ‘housing’ as used herein is meant any suitable element capable of storing a composition and/or a dispenser, such that it allows for release of the composition into the surrounding environment, external to the housing. The release of the composition from the housing may be either passive or active.

In some embodiments, the apparatus further comprises a receptacle for containing trapped Carpophilus beetles and a lid for the receptacle that allows entry of the beetles into the receptacle and discourages exit of the beetles from the receptacle. In some embodiments, the receptacle is detachable from the lid to allow for removal of the trapped beetles. The housing for storing and release of the composition may be connected to the receptacle or lid in a manner to attract beetles into the entry of the receptacle through the lid. In some embodiments, the lid of the receptacle and the housing are green, for example, medium green, medium dark green or dark green. In some embodiments, the receptacle is transparent or opaque, especially transparent. A suitable apparatus is shown in FIG. 7.

Another exemplary apparatus as described herein may include an apparatus as described in International patent application No. PCT/AU2021/050240, the entire disclosure of which is incorporated herein by reference.

In some embodiments, the apparatus further comprises one or more of:
one or more co-attractant compounds; and
an insecticide.

In a particular embodiment, the one or more co-attractant compounds may be selected from C₁-C₆ alcohols, C₁-C₄ aldehydes, indoles and C₁-C₁₂ esters. In preferred embodiments, the one or more co-attractant compounds may be selected from the group consisting of ethanol, isopentyl alcohol, acetaldehyde, isobutanol, 2-methylbutanol, ethyl acetate, isopentyl acetate, isobutyl acetate, 2-phenylethyl acetate, (E)-4,8-dimethyl-1,3,7-nonatriene (DMNT), methyl benzoate and (Z)-3-hexenyl acetate. In a particular embodiment, the one or more co-attractant compounds comprise ethanol and isopentyl alcohol, especially aqueous ethanol and isopentyl alcohol.

By the term ‘aqueous’ as used herein is meant a water-based solvent, preferably including at least approximately 40% water, especially distilled water, and may include other water-soluble or water-miscible components.

In some embodiments, aqueous ethanol is 30% to 60% ethanol in water, especially 40% to 55% ethanol in water, more especially 40% to 50% ethanol in water, for example, 45% ethanol in water.

In a one embodiment, the apparatus may comprise one or more co-attractant compounds wherein the co-attractant compounds are each in separate containers or deposit elements.

By a deposit element as used herein is meant any suitable substance in which the compound(s) can be stored and from which they can be released. In an embodiment, the deposit element may be a cotton roll/dental wick or any other such substance suitable for storage and release of the co-attractant compounds.

In some embodiments the deposit element comprising a co-attractant compound is located within a container that provides for the release of the co-attractant compound at a desired rate. In a preferred embodiment the container is made of low-density polyethylene. In one embodiment the thickness of the low-density polyethylene allows for a controlled release rate of the co-attractant compound. Preferably the container is made of low-density polyethylene having a thickness of between approximately 25 μm to 250 μm, more preferably between approximately 35 μm to 225 μm. In a particularly preferred embodiment, the container is made of low-density polyethylene having a thickness of between approximately 50 μm to 200 μm.

In an alternative embodiment, the apparatus may comprise one or more co-attractant compounds wherein the co-attractant compounds are present in a co-attractant mixture.

In a preferred embodiment, the apparatus may comprise one or more co-attractant compounds as described above present in a co-attractant mixture, wherein the mixture is in the form of a solid, liquid, gas, vapour, gel or any other suitable phase mixture thereof, preferably in the form of a liquid or gel. In a one embodiment, the apparatus may comprise one or more co-attractant compounds present in a mixture, wherein the mixture is in the form of solution, and wherein the co-attractant mixture comprises ethanol and isopentyl alcohol, especially aqueous ethanol and isopentyl alcohol. In another embodiment, the apparatus may comprise one or more co-attractant compounds present in a mixture, wherein the mixture is in the form of gel, and wherein the co-attractant mixture comprises aqueous ethanol and isopentyl alcohol. Examples of suitable gel forming components include carbomers, glycerin and tertiary amines such as triisopropanolamine.

In one embodiment, the insecticide is an organophosphate. In a preferred embodiment, the insecticide is selected from the group consisting of Dichlorvos, thiometon, naled, parathion, malathion and S-benzyl diisopropyl phosphorothiolate (IBP), especially Dichlorvos.

In some embodiments, the apparatus or dispenser provides for regulated release of the composition. In a preferred embodiment, the apparatus or dispenser provides for regulated release of the composition for between approximately 1 to 8 weeks. In a further preferred embodiment, the apparatus or dispenser provides for regulated release of the composition for between approximately 2 to 8 weeks. In a more preferred embodiment, the apparatus and/or dispenser provides for regulated release of the composition for between approximately 4 to 8 weeks.

In some embodiments, the apparatus provides for regulated release of the co-attractant compounds or co-attractant mixture. In a preferred embodiment, the apparatus provides for regulated release of the co-attractant compounds or co-attractant mixture for between approximately 1 to 8 weeks. In a further preferred embodiment, the apparatus provides for regulated release of the co-attractant compounds or co-attractant mixture for between approximately 2 to 8 weeks. In a more preferred embodiment, the apparatus provides for regulated release of the co-attractant compounds or co-attractant mixture for between approximately 4 to 8 weeks.

In some embodiments, the apparatus provides for the replacement of one or more of the composition, the co-attractant compounds or mixtures and insecticide. Replacement of these components may occur at a time when regulated release is reduced, for example, no longer efficacious in attracting and/or killing Carpophilus truncatus beetles.

In a further aspect, the present invention provides a kit comprising a composition and/or a dispenser as described herein, and a trapping device. In some embodiments, the kit comprises a composition or dispenser as described herein, and the trapping device is an apparatus comprising a housing and a receptacle with a lid as described herein. In a preferred embodiment, the kit comprises a dispenser as described herein and a trapping device. In a preferred embodiment, the components of the kit may be assembled such that in normal use the dispenser allows sustained release of the composition as described herein and the trapping device traps Carpophilus truncatus beetles. In another preferred embodiment, the components of the kit may be assembled such that the trapping device and composition is suitable for use or may be used in the methods of the present invention as described herein.

In a particular embodiment, the kit further comprises one or more of:
one or more co-attractant compounds as described herein; and
an insecticide as described herein.

In some embodiments, the kit may comprise multiple compositions of the invention, multiple co-attractant mixtures or multiple sets of co-attractants housed in separate containers and/or multiple insecticide components allowing for replacement of these components in the trapping device at intervals across a growing/harvesting season or period of monitoring, for example, when the composition. co-attractant and/or insecticide activity is reduced in effectiveness.

In a further aspect of the present invention, there is provided a method of attracting and/or trapping Carpophilus truncatus beetles, said method including the step of exposing a beetle infested environment to a composition, a dispenser and/or an apparatus as described herein.

In some embodiments, the infested environment is an orchard, more particularly a nut orchard, especially an almond orchard, a pistachio orchard, a walnut orchard, a cashew nut orchard, a kemiri nut orchard, a macadamia nut orchard and/or a Brazil nut orchard. In particular embodiments, the orchard may be an almond orchard, a pistachio orchard or a walnut orchard.

In other embodiments, the infested environment is a stockpile of nuts (stored), especially a stockpile of almonds, pistachios, walnuts, cashew nuts, kemiri nuts, macadamia nuts and/or Brazil nuts. In particular embodiments, the stockpile of nuts may be a stockpile of almonds, pistachios or walnuts.

In particular embodiments, the infested environment is an almond orchard or an almond stockpile, especially an almond orchard.

When used in a nut orchard, such as an almond orchard, infested with C. truncatus beetles, the compositions are optionally in trapping apparatus and are preferably spaced 10 m to 100 m apart in the orchard, especially 20 m to 80 m apart, more especially 30 m to 70 m apart, even more especially 40 m to 60 m apart, for example, 50 m apart. In some embodiments, the density of traps is between 3 and 25 traps per hectare, especially between 10 and 20 traps per hectare, for example between 15 and 17 traps per hectare.

In a further aspect of the present invention, there is provided a method of monitoring for the presence of Carpophilus truncatus beetles, said method including the step of positioning a composition, a dispenser and/or an apparatus as described herein, within an environment that requires monitoring for the presence of beetles.

In particular embodiments, the environment that requires monitoring for the presence of Carpophilus truncatus beetles is a nut orchard, a nut stockpile or nuts that are ready for export or are recently imported. The nut may be selected from almonds, pistachios, walnuts, cashew nuts, kemiri nuts, macadamia nuts and Brazil nuts, especially almonds, pistachios and walnuts. In a particular embodiment, the environment is an almond orchard, an almond stockpile or almonds that are ready for export or are recently imported.

In some embodiments, the composition and attractant and optionally the insecticide, may be replaced at regular intervals over the infestation period or monitoring period. For example, the composition and/or the co-attractant mixture may be replaced sometime between 1 to 8 weeks after deployment of the trap and every 1 to 8 weeks subsequently over the growing/harvesting season or monitoring period. For example, the composition and/or co-attractant mixture may be replaced every 2 to 8 weeks or every 4 to 8 weeks. In some embodiments, the insecticide may be replaced at the same time as replacing the composition and/or co-attractant mixture.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably expected to be combined by a person skilled in the art.

The present invention will now be more fully described with reference to the accompanying Examples and drawings. It should be understood, however, that the description following is illustrative only and should not be taken in any way as a restriction on the generality of the invention described above.

### BRIEF DESCRIPTION OF THE DRAWINGS/FIGURES

FIG. 1. Setup used for dynamic headspace sampling and pheromone collection.

FIG. 2. GC-MS chromatograms of almond kernels infested by either male ((♂) or female (♀) beetles. Hexanal and dimethylpyrazine are compounds that were linked to beetle infestation (absent in beetle-free kernels), regardless of beetles' sex. The remaining shaded compounds are characteristic of male beetle infestation.

FIG. 3a-e. GC-MS chromatograms from live beetle odours and synthetic pheromones (greyed). Comparisons of retention indices of natural and synthetic pheromones were used for confirmation of compound ID and authenticity. a) corresponds to the odours of male beetles feeding on artificial diet, b) is a chromatogram of male beetles' odours feeding on almond kernels; c) is a chromatogram of the synthetic Pheromone 2 supplied by Boron Molecular (Melbourne) and d) corresponds to the chromatogram of a synthetic male-specific compound (newly identified pheromone, commercially available), e) shows the overlay of FIGS. 3a-3d. Grey overlay match the retention times of individual synthetic pheromones with the retention time of natural pheromones as encountered in live beetles' extracts, being Phero #2 (Pheromone 2) and the Phero #3 (Putative Pheromone).

FIG. 4. SPME-GC-MS chromatogram representing the odour blend produced by a septum loaded with Phero #2 and Phero #3 (tetradecanal) and the antioxidant (butylated hydroxytoluene) prior to field testing.

FIG. 5. Map of the orchard block used for the field assessment of pheromone septa. Numbers represents individual trap positions in the orchard. Arrows indicate different blocks used in the randomised complete block design (10 blocks=10 replicates each containing the six test treatments).

FIG. 6. Bar chart representing beetle catches in field trials using different pheromones lures in combination with a standardised co-attractant blend. Grey bars depict C. truncatus catches and white bars the numbers of other Carpophilus beetles caught in traps (predominantly C. hemipterus). Error bars represent the standard error. Lower case lettering above grey bars indicates statistical differences between C. truncatus beetle catches of different treatments and upper-case lettering above white bars, those pertaining to other Carpophilus species. Each treatment was replicated ten times and beetle samples collected fortnightly.

FIG. 7. Representative trapping apparatus for use with the composition of the invention, FIG. 7a—assembled; FIG. 7b—disassembled.

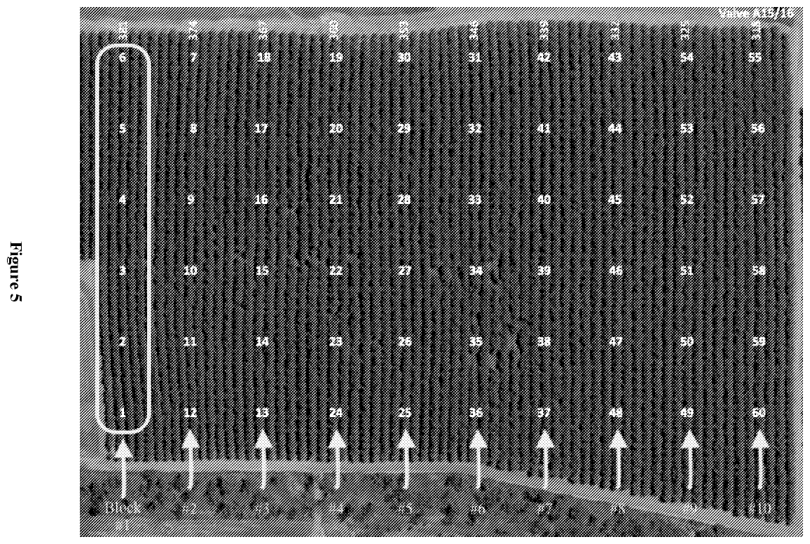

FIG. 8. Bar chart showing mean number of C. truncatus beetles caught (grey bars) and other Carpophilus species (white bars) during two week trial. Error bars represent the back transformed 95% confidence level. Upper and lower-case lettering indicate statistically significant difference in catches using different pheromone treatments for C. truncatus and other Carpophilus species respectively.

FIG. 9. Bar chart showing the number of larvae produced per 3 adult females for each nut food source used.

FIG. 10. Bar Chart showing the number of larvae to reach final instar stage per repeat for each nut food source used.

FIG. 11. A representation of the trap layout for mass trapping plot. X denotes a trap, shading denotes a sampling subplot; NP denotes a nonpareil row.

FIG. 12. A photograph of a trap fixed in place in an orchard.

FIG. 13. Bar Chart showing the total number of C. truncatus trapped per plot per fortnight.

FIG. 14. Bar Chart showing mean percent kernel damage by C. truncatus under Control and Mass Traps Treatments. Error bars show the SEM.

### DETAILED DESCRIPTION OF THE PREFERRED EMBODIMENTS

### Example 1—Specimen and Pheromone Collection

i. Plants and Insects

Raw almonds used in all experiments were collected in a commercial almond orchard located near Mildura (Victoria, Australia). Carpophilus beetles (Carpophilus truncatus) used to infest almonds were obtained from laboratory colonies maintained at the AgriBio Centre for AgriBiosciences (Bundoora, Australia); the cultures having been established from wild-caught beetles originating from the same orchard. Freshly emerged beetles were collected and sexed under a stereomicroscope before nut infestation.

ii. Chemicals

The previously identified C. truncatus pheromone compound, Pheromone 2: (E,E,E,E)-3,5,7-trimethyl-2,4,6,8-undecatetraene (as disclosed in PCT/AU2021/050242 above), was synthesized by Boron Molecular (Noble Park, VIC, Australia). The newly identified pheromone compound, tetradecanal, was purchased from Ambeed products (Ambeed Inc., USA) via their regional distributor (Sigma Aldrich Australia). Dicholoromethane, ethanol (96% purity), nonyl acetate, butylated hydroxytoluene and isopentyl alcohol were purchased from Sigma-Aldrich (Castle Hill, NSW, Australia).

iii. Volatile Collection

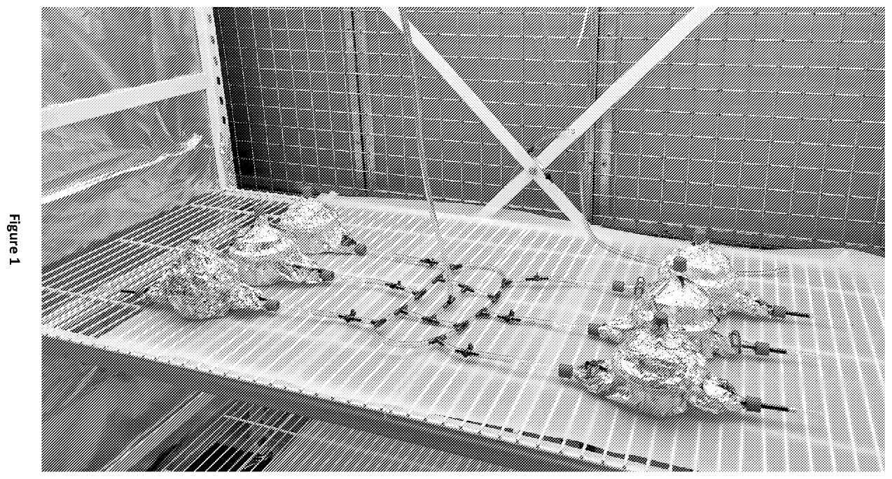

Volatiles emanating from beetle-free (uninfested) and infested kernels were collected by dynamic headspace sampling in an apparatus as shown in FIG. 1. Three treatments were established for odour sampling: (i) male beetles, (ii) female beetles, (iii) no beetles. For each treatment group twenty-five kernels (15 intact and 10 cut in half) were placed in a 300 mL glass vessel used for collecting volatiles. Treatments containing beetles (i and ii), included 60 adult insects of the required sex. Beetles were allowed to feed on the kernels for a week prior sampling. Volatile collections were undertaken by circulating an airflow through two glass sockets used as inlets and outlets situated on opposite sides of the glass vessels. Purified air, pulled through an activated charcoal filter fitted at the inlet (outer sides), entrained the volatiles inside the chamber at a set flow rate (100 mL·min⁻¹) onto an adsorbent filter connected at the outlet (inner side where the vacuum was applied). Collection vessels were wrapped in aluminium foil to create a dark environment preferred by the beetles. Multiple collections were conducted simultaneously using a six-arm manifold made of PVC tubing connected to a single vacuum point (as shown in FIG. 1). The airflow in different arms of the manifold was adjusted using small valves and controlled with an airflow meter. The adsorbent filters used to trap volatiles consisted of 100 mg of Porapak Q powder, packed between two silanized glass wool plugs inside glass Pasteur pipettes. Volatiles were collected from twelve samples of each treatment for 7 days. At the end of the collections, volatiles were eluted from the adsorbent filters using 2 mL of dichloromethane. 500 ng of nonyl acetate used as an internal standard (IS) was added to the samples before these were condensed to a final volume of approximately 100 μL by solvent evaporation under a gentle stream of nitrogen.

### Example 2—Chemical Analysis of Pheromone Samples

The pheromone samples obtained according to Example 1 were subsequently used for chemical analysis and field experiments.

Volatile samples dissolved in dichloromethane were analysed by Gas Chromatography coupled with Mass spectrometry (GC-MS). Aliquots of 2 μL were injected at 250° C. in spitless mode using an Agilent 7650 ALS autosampler in an Agilent 7890B gas chromatograph equipped with an Ultra Inert HP-5MS capillary column (30 m×0.25 mm×0.25 μm) and coupled with a single quadrupole Agilent 5977B mass spectrometer. Initial oven temperature was set at 40° C. held for 2 min, then increased 10° C.·min⁻¹ to 220° C. and then at 20° C.·min⁻¹ to a final temperature of 300° C. maintained for a minute. Mass spectra were acquired in EI mode (70 eV) with the mass scan range set between 35 and 550. Quadrupole and ionisation source temperatures were set at 150° C. and 230° C., respectively. Compounds were tentatively identified using a NIST 14 mass spectral library and by the comparison of their Kovats indices to indices directly available literature or by injecting commercial synthetics.

### Data Analysis

Chromatographic data from GC-MS analyses of almond and beetle volatiles were extracted using the built-in deconvolution and peak alignment tools from the eRah package in R studio (Domingo-Almenara et al. 2016). Comparison of extracted peak areas against the peak areas of the internal standard were used to estimate the quantities of different compounds in ng IS equivalent/week. Differences between the estimated quantities obtained in the headspace of control, male and female-infested kernels were then tested in ANOSIM (analysis of similarities) using a Bray-Curtis dissimilarity matrix. The indicspecies package (De Cáceres et al. 2011) was used for multi-level pattern analysis to investigate the compounds characteristic of different odour profiles.

Results—Analysis of Volatiles Emanating from Infested and Beetle-Free Almond Kernels

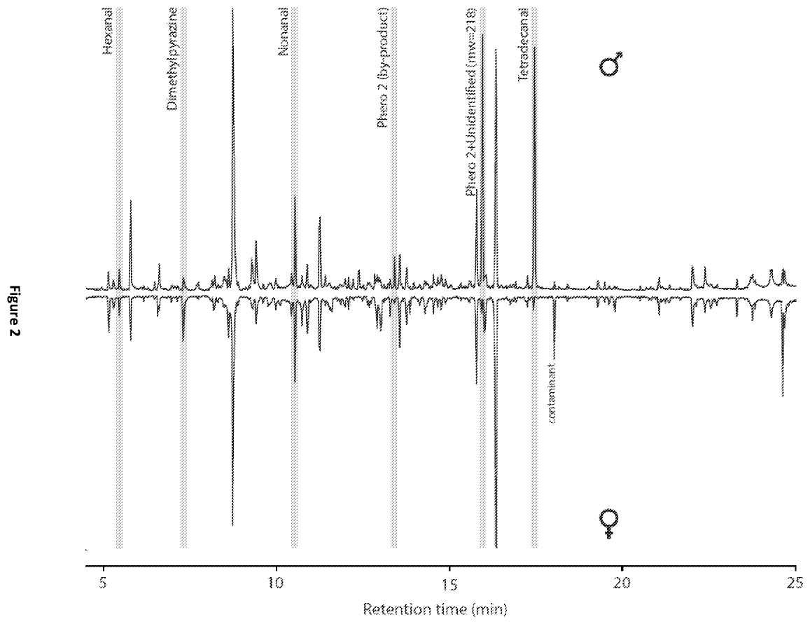

GC-MS analysis of odour extracts (FIG. 2) demonstrates differences between the chemical profiles of beetle-free and infested almond kernels. A dimethylpyrazine compound (2,5- or 2,6) almost absent in the headspace of beetle-free kernels was present in infested samples regardless of beetle sex. Increased concentrations of hexanal were also observed in the odour of kernels infested by beetles of both sexes. Four compounds were identified as specific to male beetle infestation using multilevel pattern analysis.

Among these compounds were (2E,4E,6E,8E)-3,5,7-trimethyl-2,4,6,8-undecatetraene (Pheromone 2 or Phero #2) which was previously identified as the predominant C. truncatus pheromone (identified in PCT application PCT/AU2021/050242, the entirety of which is incorporated herein by reference), an unidentified compound (mw=218), and a compound identified with a high level of confidence by the mass spectral library as tetradecanal. A weak but significant increase of nonanal was associated with male-beetle infestation. The results of GC-MS analysis and significance of statistical associations with different profiles are presented in Table 1.

GC-MS chromatograms of almond kernels infested by either male (♂) or female (♀) beetles are shown in FIG. 2.

TABLE 1
GC-MS analysis results of control (beetle-free), adult female and male-infested almond
kernels expressed in nonyl acetate (IS) ng equivalent/week (±standard error).

| | | | Control | Females | Males | Indicspecies |
|---|---|---|---|---|---|---|
| Tentative Compound ID | KI | KI lit | n = 12 | n = 12 | n = 12 | stat, p value |
| 2,3-Butanediol, peak 1 | 795 | 788 | 1753 ± 319 | 2062 ± 366 | 1653 ± 332 | |
| 2,3-Butanediol, peak 2 | 803 | 802 | 738 ± 151 | 791 ± 160 | 722 ± 152 | |
| Hexanal | 812 | 800 | 266 ± 25 | 469 ± 45 | 593 ± 51 | 0.648, p = 0.0001 |
| p-Xylene | 867 | 865 | 740 ± 114 | 579 ± 72 | 601 ± 95 | |
| 1-Hexanol | 872 | 868 | 898 ± 123 | 873 ± 91 | 653 ± 146 | |
| m-Xylene | 874 | 866 | 1877 ± 283 | 1319 ± 204 | 1590 ± 216 | |
| (2,6 or 2,5-)Dimethylpyrazine | 914 | 917 | 15 ± 3 | 1699 ± 249 | 1248 ± 125 | 0.773, p = 0.0001 |
| α-Pinene | 936 | 929 | 640 ± 95 | 625 ± 115 | 720 ± 146 | |
| Benzaldehyde | 963 | 962 | 1395 ± 190 | 1148 ± 135 | 1281 ± 196 | |
| Mesitylene | 964 | 972 | 1137 ± 256 | 858 ± 187 | 1205 ± 300 | |
| Sabinene | 978 | 974 | 516 ± 73 | 373 ± 58 | 469 ± 96 | |
| Hexanoic acid | 986 | 990 | 2631 ± 297 | 1908 ± 261 | 2601 ± 184 | |
| o/m-Cymene | 1027 | 1023 | 2094 ± 541 | 2469 ± 633 | 3588 ± 1098 | |
| 2-Ethyl-1-hexanol, | 1028 | 1030 | 4096 ± 900 | 3088 ± 546 | 4455 ± 1008 | |
| Limonene | 1032 | 1030 | 1044 ± 210 | 935 ± 216 | 1477 ± 387 | |
| Eucalyptol | 1035 | 1032 | 1605 ± 362 | 1458 ± 254 | 1947 ± 456 | |
| Benzyl alcohol | 1036 | 1036 | 1351 ± 210 | 1017 ± 161 | 1406 ± 294 | |
| Benzeneacetaldehyde | 1048 | 1045 | 411 ± 34 | 494 ± 38 | 500 ± 64 | |
| 1-Octanol | 1071 | 1071 | 880 ± 143 | 535 ± 71 | 832 ± 157 | |
| Unidentified | 1103 | — | 810 ± 83 | 565 ± 74 | 739 ± 99 | |
| δ-Caprolactone | 1105 | 1084 | 795 ± 84 | 494 ± 103 | 858 ± 239 | |
| Nonanal | 1107 | 1104 | 2477 ± 342 | 2720 ± 406 | 4327 ± 854 | 0.414, p = 0.036 |
| Phenylethyl Alcohol | 1120 | 1116 | 1772 ± 128 | 809 ± 60 | 876 ± 103 | |
| N-Formylmorpholine | 1130 | 1133 | 1338 ± 347 | 1463 ± 251 | 2417 ± 500 | |
| Dodecane | 1200 | 1200 | 741 ± 112 | 400 ± 63 | 533 ± 110 | |
| Benzothiazole | 1236 | 1229 | 635 ± 134 | 403 ± 84 | 588 ± 149 | |
| Nonanoic acid | 1272 | 1273 | 1654 ± 331 | 711 ± 154 | 1648 ± 528 | |
| Tetradecane | 1400 | 1400 | 832 ± 131 | 528 ± 90 | 598 ± 107 | |
| Unidentified (mw = 220) | 1479 | — | 6551 ± 1318 | 3541 ± 460 | 4607 ± 707 | |
| Phero 2: (2E,4E,6E,8E)-3,5,7- | 1489 | 1484 | — | — | 2133 ± 339 | 0.728, p = 0.0001 |
| trimethyl-2,4,6,8-undecatetraene | | | | | | |
| Unidentified (mw = 218) | 1490 | — | 1025 ± 248 | 320 ± 77 | 2276 ± 362 | 0.648, p = 0.0001 |
| Pentadecane | 1500 | 1500 | 542 ± 113 | 449 ± 84 | 640 ± 142 | |
| BHT | 1525 | 1518 | 31703 ± 3533 | 23044 ± 2467 | 24286 ± 2112 | |
| Hexadecane | 1600 | 1600 | 488 ± 127 | 364 ± 78 | 571 ± 153 | |
| Tetradecanal | 1613 | 1613 | 275 ± 66 | 109 ± 37 | 2685 ± 265 | 0.912, p = 0.0001 |

Compounds in bold were identified as associated with the presence of male or female beetle of both using the indicspecies package

### Verification of Compound ID Using Synthetics

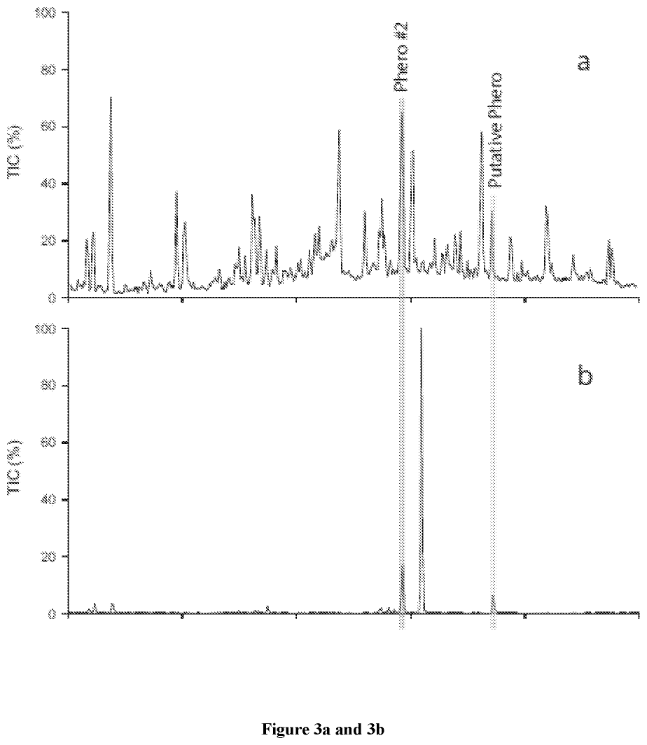

The authenticity and purity of compounds were verified by GC-MS analysis by comparison of the mass spectra and retention indices from synthetic compounds with those obtained from beetle odour extracts fed on almond kernels (see FIG. 3a-e).

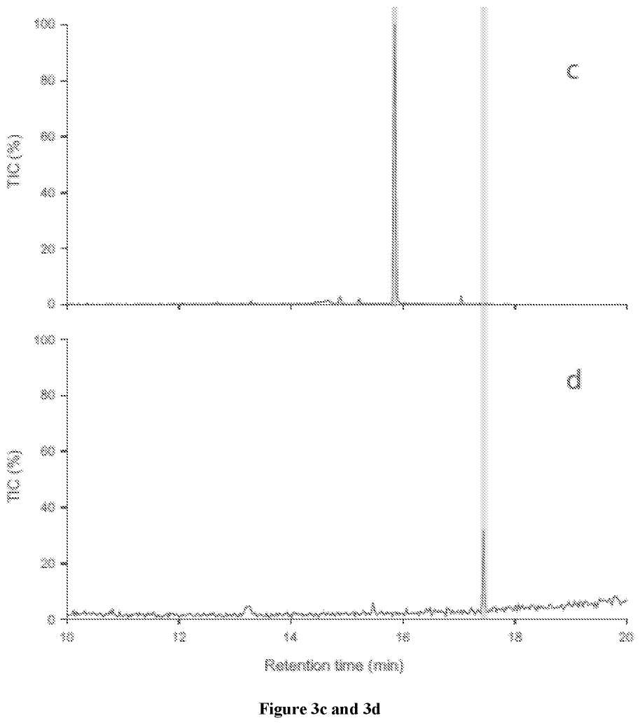

Mass spectra of the synthetic compounds matched those of their natural counterparts and their retention indices were close enough to infer their authenticity (pheromone 2 [(2E,4E,6E,8E)-3,5,7-trimethyl-2,4,6,8-undecatetraene]: 1486 vs 1489, pheromone 3 [tetradecanal]: 1616 vs 1613). The purity of the newly prepared synthetic pheromone (Pheromone 2) was 86% and that of Pheromone 3 (tetradecanal) was around 97%. Quantities of the two compounds loaded on rubber septa were adjusted using SPME-GC-MS analysis for the compounds to be released in approximately equal ratios. The results of this analysis are shown in FIG. 4.

### Example 3—Field Experiments of Pheromone Samples

A field experiment was designed to test the attractancy of the previously described C. truncatus Pheromone 2 under field conditions and the pheromonal (attractant) activity of newly identified Pheromone 3. Pheromones were tested individually or in combination at ratios comparable to those encountered in biological samples, and trials included the current commercialised pheromone mix developed to control stonefruit Carpophilus (“tri-species lure”, Catcha® Pheromone lure, Insect Management Services, Baccus Marsh, VIC, Australia). All pheromones were tested together with a co-attractant mixture in the form of an aqueous ethanol and isopentyl alcohol solution, which acts synergistically to elicit a strong behavioural response in C. truncatus.

Pheromone test lures were loaded on white Precision Seal® rubber septa (8 mm OD, Sigma Aldrich product code: Z553913) with butylated hydroxytoluene used an antioxidant. The quantities of individual compounds applied on the septa were determined by SPME-GC-MS analyses of test septa at days 1 and 3 to produce the two pheromones in approximately equal ratios. The quantity of antioxidant was chosen based on the existing literature as 10% of the ratio of the dominant pheromone (Table 2). Hexane dilutions of the neat pheromones were prepared, and desired quantities loaded onto the septa. Loaded septa were allowed to dry under a fume hood overnight and stored in heat-sealed foil bags at −20° C. until use in field trials.

TABLE 2
Pheromone mixes used as treatments and co-attractant solution
applied with alongside tested in the field trial.

| Lure septa | Composition & quantities applied | Co-attractant |
|---|---|---|
| Tri-species | Seven described Carpophilus pheromones | Isopentyl |
| Phero 2 | (15 mg) (E,E,E,E)-3,5,7-trimethyl- | alcohol: |
| | 2,4,6,8-undecatetraene (3 mg) | 2 mL |
| | Butylated hydroxytoluene (0.25 mg) | 45% ethanol: |
| Phero 2 + 3 | (E,E,E,E)-3,5,7-trimethyl-2,4,6,8- | 248 mL |
| | undecatetraene (3 mg) | |
| | Tetradecanal (10 mg) | |
| | Butylated hydroxytoluene (0.25 mg) | |

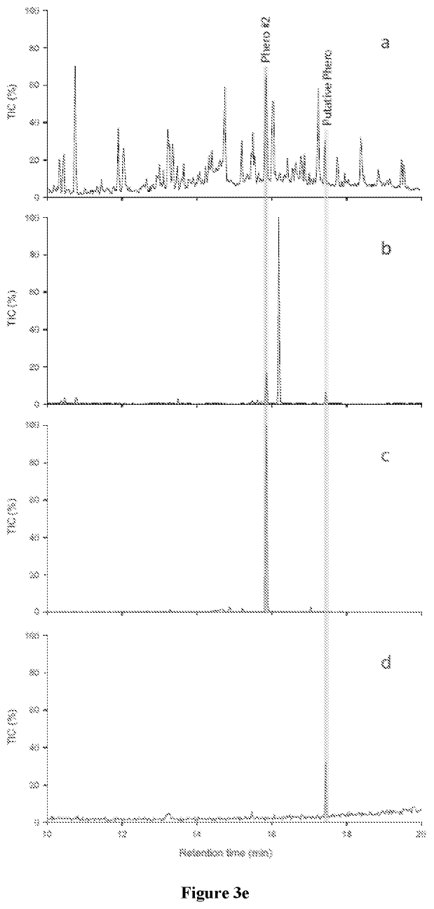

The field trial was carried out from December 2021 in a commercial almond orchard located near Mildura, Victoria, Australia. The orchard block was selected based on its size (being large enough to accommodate the trial) together with the confirmed presence of C. truncatus populations in sentinel traps and nuts on the ground. Pheromone septa were hung using paperclips inside black bucket traps (Carpophilus Catcha trap, Bugs for Bugs, Toowoomba, QLD) containing 250 mL of a co-attractant solution optimised for the capture of C. truncatus (PCT/AU2021/050242, the entirety of which is incorporated herein by reference) and a strip of insecticide (Killmaster, Dichlorvos, 15 mm×15 mm). The traps were spaced no less than 50 m apart with treatments arranged in a Randomised Complete Block design (a block corresponding to a transect of 6 traps), replicated ten times (as shown in FIG. 5). Lure septa and co-attractant solutions were replaced fortnightly at the same time as beetle samples were collected. Beetles present in different traps were identified and counted under a stereomicroscope. The trial was run for a total of 6 weeks.

### Data Analysis

Field data were analysed using a Generalized Linear Mixed Model (GLMM) fitted with a negative binomial distribution using the glmmTMB package (Brooks et al. 2019). Counts of C. truncatus and other Carpophilus beetles' catches were used as response variable with “lure treatment” set as the fixed factor. Other random variables such as “date” of the assessment accounting for temporal variations of beetle populations during the trial as well as “block” and “rows” to control for heterogeneous spatial distributions of beetles within the block were used as random factor when they contributed to improve the fit. The Ismeans package (Lenth 2016) was used for multiple comparisons testing (adjusted Tukey's post hoc tests).

### Attraction of Previously Identified and New Putative Pheromones in Field Trials

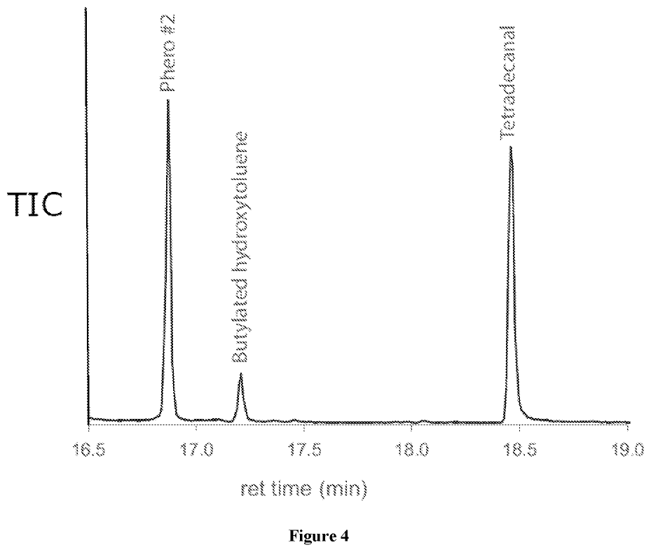

The best model fit for C. truncatus beetle catches data used treatment as fixed factor with “date” and “blocks” as random variables (due to a gradient in beetle population across the block). The number of C. truncatus caught varied significantly according to the pheromone mixes loaded on the septa (χ²=822, df=5, p<0.001). The results from this study are shown in FIG. 6.

It was observed that septa loaded with Pheromones 2 & 3 caught significantly more C. truncatus beetles than all the other treatments (p<0.001). Further, septa comprising Pheromone 2 alone caught significantly more beetles than the commercial tri-species septa (p<0.001).

Catches of other Carpophilus species (in which C. hemipterus were largely overrepresented), were interpreted using a similar model with the addition of “row” as random variable to account for the greater catches observed on the edges of the orchard. Beetle catches with the treatments did not differ significantly.

### Example 4—Field Experiment of Pheromone Samples

A short trial was carried out over two weeks. Treatments were randomised and replicated in 10 tree rows with approximately 50 m spacing between traps (10 rows×2 treatments—20 repeats per treatment; 3 treatments of 20 repeats is 60 traps used). The treatments are shown in Table 3:

TABLE 3
Lure treatments used in the field trial

| Treatments | Septa composition | Co-attractant |
|---|---|---|
| Phero 3 | Tetradecanal (10 mg) | 250 ml of |
| | BHT (0.3 mg) | Isopentyl alcohol: |
| Phero 2 | (2E,4E,6E,8E)-3,5,7-trimethyl-2,4,6,8- | 800 μL/100 ml |
| | undecatetraene (3 mg) | in |
| | BHT (0.3 mg) | 45% ethanol - |
| Phero 2 + | (2E,4E,6E,8E)-3,5,7-trimethyl-2,4,6,8- | water |
| Phero 3 | undecatetraene (3 mg) | |
| | Tetradecanal (10 mg) | |
| | BHT (0.3 mg) | |

Data was analysed in a similar way to Example 3 using GLMM with trap catches as response variable, lure treatment as fixed factor and row and column as random (spatial features). Turkey's adjusted post hoc tests for multiple comparisons of a family of three estimates. The results of the mixed model are: Wald χ2=62.5, df=1, p=2.64 10⁻¹⁴. Multiple comparisons are shown in Table 4.

TABLE 4

| Treatments | df | t-ratio | p value |
|---|---|---|---|
| Phero 3 vs Phero 2 | 57 | −6.535 | <0.0001 |
| Phero 3 vs Phero 2 + 3 | 57 | −7.831 | <0.0001 |
| Phero 2 vs Phero 2 + 3 | 57 | −1.495 | 0.3008 |

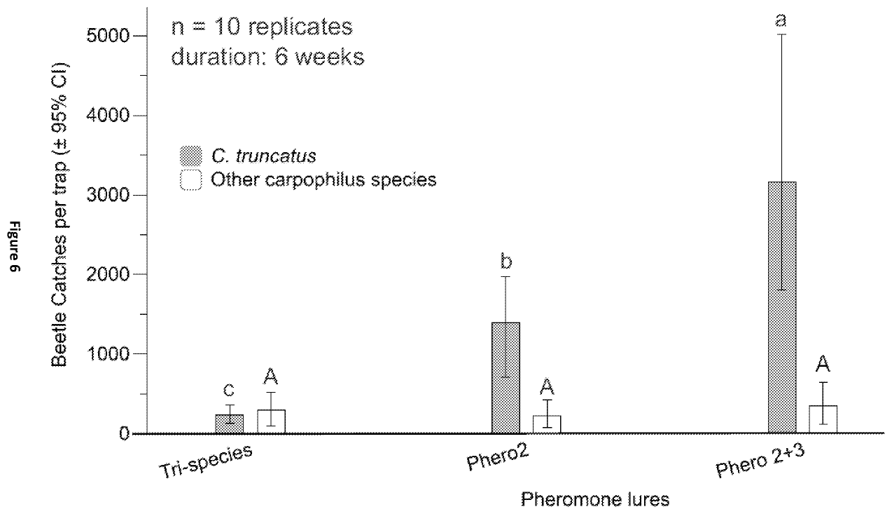

FIG. 8 shows that Phero 3 caught significantly less C. truncatus and other Carpophilus species beetles than Phero 2 and Phero 2+Phero 3 suggesting that Phero 3 acts in a synergistic way with Phero 2. However, although Phero 2+Phero 3 caught more C. truncatus than Phero 2, the difference was not statistically significant. These results differ from the results in Example 3 where Phero 2 and 3 was the most effective treatment by a significant margin. Beetle populations in the orchard were considerably higher in Example 4 (as reflected by the high trap counts across treatments) and this may well have influenced trap catches across treatments—for example, it has been shown in lure formulations in fruit flies, that field trials conducted under high pest pressure showed a similar lack of statistical significance among lure treatments, compared to lower pest pressure (Henneken et. al. 2022, Cunningham et al. 2018). Results such as this emphasise how maximum effectiveness of lure technologies is most likely under lower pest pressure.

### Example 5—Nut Feeding Trials

A laboratory colony of Carpophilus truncatus was established by collecting mummy nuts from commercial almond orchards in the Sunraysia growing region of Victoria, Australia. Insects were cultured on a sugar-soybean diet at 25° C. 12 h-12 h day-night and 60% relative humidity. The colony was maintained at the AgriBio Centre for AgriBioscience in Bundoora, Victoria, and all beetles used in experiments were taken from the laboratory colony.

Nine nut or seed commodities were selected for host suitability trials based on known or potential use by C. truncatus, covering both commercial crop and native plant species, to determine the fundamental host range of C. truncatus on nut-like substrates. For both adult survival and larval development trials, ten replicates of each nut species were prepared by roughly chopping 1.5 g of nut to expose the interior for beetle access. Chopped nut was placed in 5 mL plastic specimen tubes secured with a muslin cloth cover and screw top lid with a 3.5 mm hole, allowing air flow but maintaining a humid microclimate. For the control group and in order to establish baseline parameters for life traits, an equivalent volume of chopped mounting polystyrene was used to provide microhabitat and maintain moisture similar to the treatments, but with no edible resource available.

### Adult Survival and Acceptability

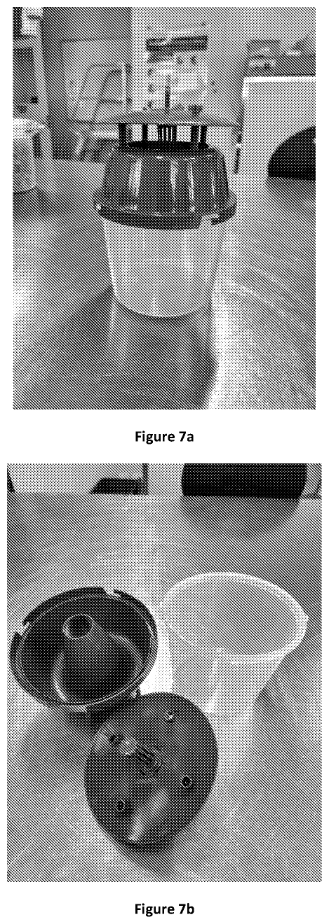

Six freshly-eclosed adult Carpophilus beetles—three males and three females—were placed in each tube and monitored daily for survival as well as F1 generation larvae. Numbers were chosen to avoid premature death, especially during the first several days of the trial, as the species is aggregating and performs poorly when lone, unfed beetles are exposed to nut substrate. All tubes were misted daily with water to maintain adequate moisture. The date of death was recorded for all adults until trial completion at 100 days, as well as the number of 5th instar larvae that were produced by each tube over the length of the trial period. When nut became overly moist due to the action of many F1 larvae, or when the commodity was becoming close to exhausted, adults were transferred to a fresh tube of chopped nuts. Upon trial completion, all adults and larvae were removed and preserved in 100% ethanol. A portion of F1 larvae from each treatment were reared to adulthood to ensure that the adults were fertile and were free of abnormalities. The average number of larvae produced is shown in FIG. 9.

### Larval Development

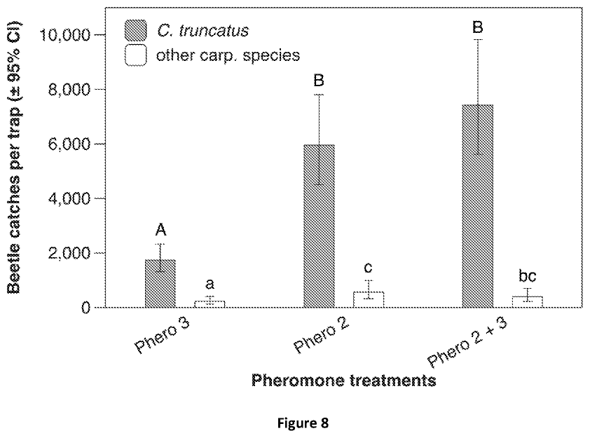

Six freshly oviposited C. truncatus eggs were carefully transferred onto the chopped nuts in each tube using a sterile, moistened brush. Tubes were monitored daily and the date recorded when 5th instar larvae had developed and were ready for pupation. Tubes continued to be monitored for 1 month after the final larvae had been observed, at which time any remaining larvae were assumed dead. A portion of the insects from each treatment were reared to adulthood to ensure that the adults were fertile and were free of abnormalities. The number of days to reach 5th instar are shown in FIG. 10.

### Example 6—Attract and Kill Field Trial

### Aim

Determine the degree to which kernel damage in almonds may be reduced by mass trapping of C. truncatus using attractants.

### Materials & Methods

### Trial Site

This trial was located on a mature, commercial almond orchard in the Robinvale district of Victoria. Fifteen orchard blocks potentially suitable for hosting trial plots were identified based on their size and the levels of Carpophilus kernel damage recorded at the previous harvest. These blocks had 16 to 17-year-old trees on double-line drip irrigation with tree and row spacings of 4.65 m and 7.25 m respectively.

The presence of Carpophilus infestation in mummy nuts on the orchard floor across those 15 blocks was assessed in mid-September 2023. The assessments were performed in every sixth row (43.5 m) and every 10th (46.5 m) or 15th (69.75 m) tree. At each assessment point, up to ten nuts were opened and inspected for live Carpophilus, with the inspection stopping as soon as beetles were seen. From this assessment, ten blocks were selected for the trial based on their relatively wide distribution of live Carpophilus.

### Experimental Design

This trial employed a randomised block design using matched pairs. The ten orchard blocks selected for the trial were paired based on having similar Carpophilus damage levels recorded at the previous harvest. Two treatments, ‘Mass Traps’ and ‘Control’, were allocated randomly to each pair of blocks, providing five replicates of each treatment.

High levels of kernel damage at harvest have previously been observed in trees up to 90 m from areas that experienced high levels of mummy nut infestation by C. truncatus during winter. Based on that observation, to minimise edge effects in this current trial, a plot size of 5.67 ha (1,683 trees) was used. This allowed for a trapping zone of at least 100 m around a ‘sampling subplot’ of 35 trees, including 21 Nonpareil trees that would be used for the collection of nut samples for damage assessments. The same plot/subplot layout applied to Control blocks.

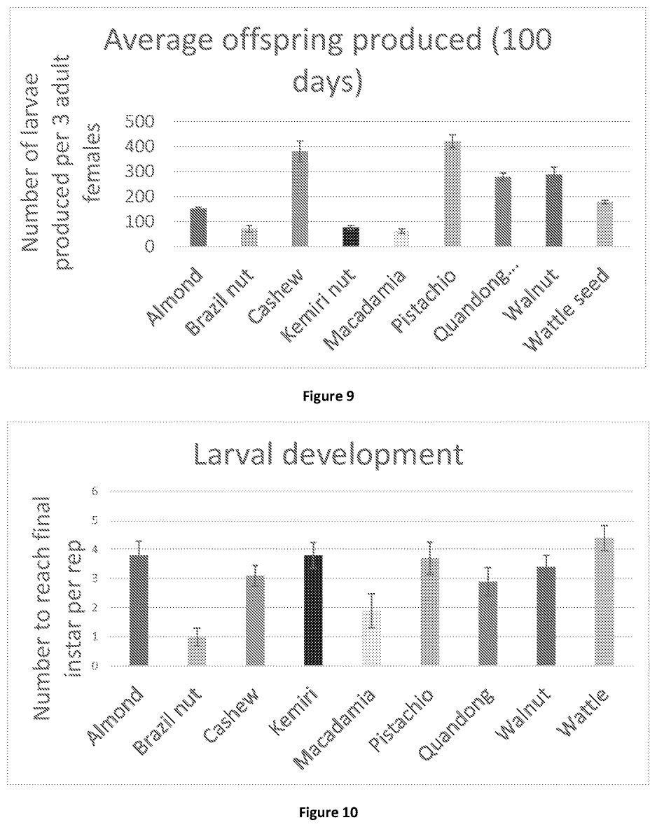

Ninety four traps were installed in each of the Mass Traps plots as shown in FIG. 11, providing a density of 16.6 traps/ha.

### Trap Components and Maintenance

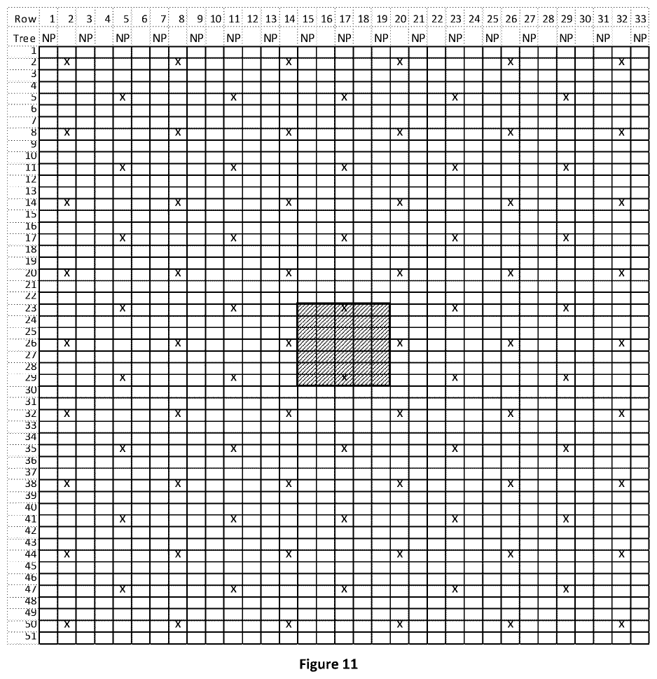

All traps used in this trial were identical, and consisted of:
A bucket/funnel trap (26.5×31×41 cm) with green rain cap and funnel on a clear bucket, available commercially as the ‘Carpophilus Angler Trap’ (GroChem, Melbourne Australia). Each trap was secured at ground level using a custom-made metal stake and ring, with rubber tree ties holding the trap in place as shown in FIG. 12.
A rubber pheromone septum (Precision Seal™ white rubber septa) loaded with (2E,4E,6E,8E)-3,5,7-trimethyl-2,4,6,8-undecatetraene (3 mg), Tetradecanal (10 mg) and BHT (0.3 mg).
250 mL of co-attractant solution comprising 45% aqueous ethanol and isopentyl alcohol (800 μL/100 ml) in a plastic tub, covered with fine gauze to prevent beetles from entering the tub.
A 1 cm×1 cm piece of Killmaster pesticide strip (Dichlorvos) (Barmac Industries Pty. Ltd., Queensland, Australia) to kill beetles that enter the trap.

Fresh co-attractant solution was prepared in advance and stored at 4° C. until required. The co-attractant and pheromone septum were renewed fortnightly while the pesticide strips were replaced monthly.

### Timeline

Trap hardware was installed in late September/early October and the traps were first loaded with pheromone septa, co-attractant and pest strips on October 10 and 18. The traps in each experimental plot were maintained until nut samples were collected from that plot, with the earliest samples collected on 15 Feb. 2024 and the latest on 1 Mar. 2024.

### Data Collection

### Trap Catches

Trap catches were collected fortnightly. Insects caught within each of the five Trapped plots were pooled into a single sample per plot, sealed in a labelled plastic zip lock bag and stored temporarily at 4° C. After removing any non-Carpophilus specimens, the samples were then stored at −20° C. before being sent to Agriculture Victoria's AgriBio Centre (Bundoora, Victoria) for identification. All samples were measured volumetrically using a graduated measuring cylinder.

For each sample date, a 2 mL subsample from each Trapped plot was sorted and identified to species, using morphological keys and a stereomicroscope. The number of C. truncatus/mL was then used to convert the total beetle volumes to total counts of C. truncatus captured per plot.

For fifteen samples collected over six sample dates between early December 2023 and early February 2024, the sex ratio of trapped C. truncatus was assessed. For this, 20 beetles were selected at random from the C. truncatus sorted from the 2 mL subsample as described above, and their sex determined under a stereomicroscope.

### Kernel Damage

Ten of the 21 Nonpareil trees in each sampling subplot were selected randomly for nut sampling. One hundred new crop nuts were collected from the ground under each of the ten selected trees shortly after the trees were shaken for commercial harvest. All nut samples were stored at approximately 4° C. in open-weave onion bags to allow drying to continue while preventing further kernel damage from Carpophilus beetle or carob moth. The presence of kernel damage by Carpophilus beetle was assessed by manual cracking of the nuts followed by visual inspection using a Maggylamp or stereomicroscope when necessary.

### Data Analysis

All statistical tests were performed using GenStat (VSN International, 2023). To determine whether variation in the observed levels of insect damage could be explained by treatment, a restricted maximum likelihood model (REML) analysis was performed, which included Block ID as a random effect.

### Results & Discussion

### Trap Catches

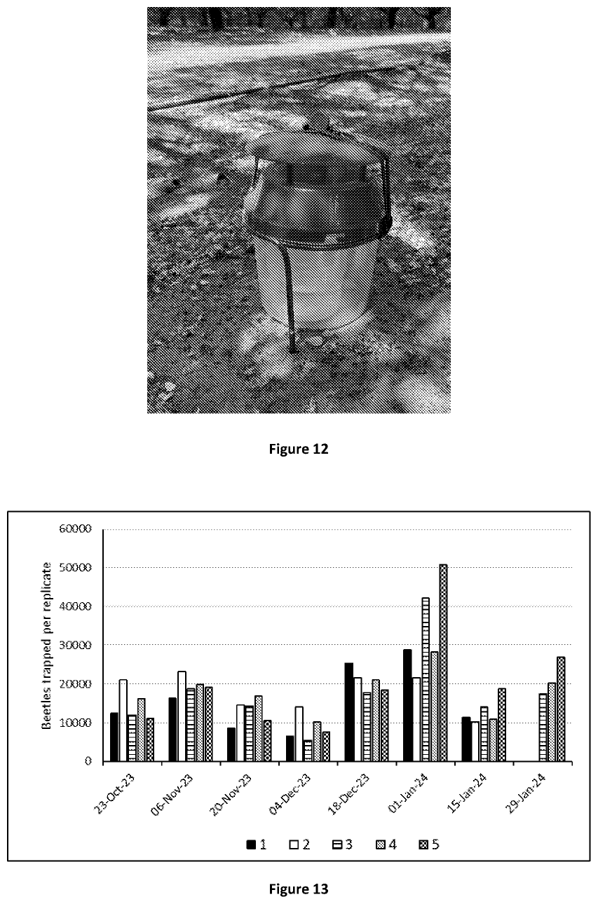

Beetle samples collected from the traps up to February 1st have been processed, with a total catch to that date of just under 684,000 C. truncatus (FIG. 13).

On average, C. truncatus made up 96.4% of the total beetle catch, highlighting the specificity of the lure to that species. Interestingly, the sex ratio of C. truncatus in 15 samples averaged 68% female. This bias towards females adds value to the trapping program, by increasing the impact that trapping has on the reproductive potential of the C. truncatus population.

### Kernel Damage

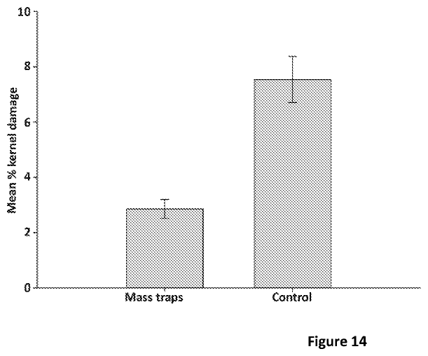

The REML model revealed a significant treatment effect on the level of kernel damage. Significantly less damage was observed in the Mass Traps treatment compared to Control (FIG. 14) (df=1. F=6.78, p=0.031). Block ID contributed to just 0.26% of the observed variation in insect damage, suggesting that the block pairs were well-matched. Table 5 shows the mean percent kernel damage, and reduction in damage by mass trapping, for each plot pair.

TABLE 5
Mean percent kernel damage in trapped and control plots.

| | | Mean % | % reduction in |
|---|---|---|---|
| Plot | | kernel | kernel damage by |
| pair | Treatment | damage | trapping |
| 1 | Trapped | 2.6% | 63.4% |
| | Control | 7.1% | |
| 2 | Trapped | 5.6% | 60.6% |
| | Control | 14.2% | |
| 3 | Trapped | 1.6% | 61.0% |
| | Control | 4.1% | |
| 4 | Trapped | 2.6% | 18.8% |
| | Control | 3.2% | |
| 5 | Trapped | 1.9% | 79.1% |
| | Control | 9.1% | |

| | |
|---|---|
| Mean | 56.6% |

This first A&K trial shows that the lure has potential for use in mass-trapping.

An anomaly in these data is the low percent reduction in kernel damage in plot pair 4 (18.8%) compared to the mean percent reduction across the other four plot pairs (66%). There was a perception by the nut assessor that the sample from the control plot in plot pair 4 contained a considerable number of nuts with sealed shells which are less likely to suffer kernel damage by Carpophilus, and so skew the results.

### CONCLUSIONS

The average and maximum reductions in kernel damage of 56% and 79% respectively, achieved by the mass ‘attract & kill’ treatment employed during this trial are very promising. Also promising is the fact that kernel damage was held below an informal industry threshold of 2% in two of the five trapped plots.

The improved co-attractant and new pheromone blend is highly selective to C. truncatus which made up over 96% of the total catch of Carpophilus beetles. As a result, the current trap and lure can be used by producers as a reliable monitoring tool for the species.

Finally, it is to be understood that various alterations, modifications and/or additions may be made without departing from the spirit of the present invention as outlined herein.

### REFERENCES

Bartelt R J (2010) Volatile hydrocarbon pheromones from beetles. In: Blomquist G J, Bagnieres A-G (eds) Insect Hydrocarbons: Biology, Biochemistry, and Chemical Ecology. Cambridge University Press, pp 448-476
Bartelt R J, Dowd P F, Plattner R D, Weisleder D (1990) Aggregation pheromone of dried fruit beetle, Carpophilus hemipterus Wind-tunnel bioassay and identification of two novel tetraene hydrocarbons. J Chem Ecol 16:1015-1039. doi: 10.1007/BF01021008
Bartelt R J, Weisleder D, Dowd P F, Plattner R D (1992) Male-specific tetraene and triene hydrocarbons of Carpophilus hemipterus: Structure and pheromonal activity. J Chem Ecol 18:379-402. doi: 10.1007/BF00994239
Brooks M E, Kristensen K, Darrigo M R, et al (2019) Statistical modeling of patterns in annual reproductive rates. Ecology 100:e02706. https://doi.org/10.1002/ecy.2706
De Cáceres M, Sol D, Lapiedra O, Legendre P (2011) A framework for estimating niche metrics using the resemblance between qualitative resources. Oikos 120:1341-1350. https://doi.org/10.1111/j.1600-0706.2011.19679.x
Domingo-Almenara X, Brezmes J, Vinaixa M, et al (2016) ERah: A Computational Tool Integrating Spectral Deconvolution and Alignment with Quantification and Identification of Metabolites in G C/M S-Based Metabolomics. Anal Chem 88:9821-9829. https://doi.org/10.1021/acs.analchem.6b02927
Lenth R V (2016) Least-Squares Means: The R Package Ismeans. J Stat Softw 69:1-33. https://doi.org/10.18637/jss.v069.i01

1.-32. (canceled)

33. A composition for attracting Carpophilus truncatus beetles, the composition comprising 3,5,7-trimethyl-2,4,6,8-undecatetraene or a geometric isomer thereof and one or more C₆-C₁₆ aldehydes.

34. The composition according to claim 33, wherein the 3,5,7-trimethyl-2,4,6,8-undecatetraene is (E,E,E,E)-3,5,7-trimethyl-2,4,6,8-undecatetraene.

35. The composition according to claim 34, wherein the one or more C₆-C₁₆ aldehydes is a saturated aldehyde, optionally wherein the one or more C₆-C₁₆ aldehydes is selected from tetradecanal, hexanal and nonanal, optionally wherein the one or more C₆-C₁₆ aldehydes is tetradecanal.

36. The composition according to claim 33, further comprising a dimethyl pyrazine.

37. The composition according to claim 33, further comprising an antioxidant, optionally wherein the antioxidant is selected from butylated hydroxytoluene (BHT), butylated hydroxyanisol (BHA), tocopherols, ascorbic acid and citric acid.

38. The composition according to claim 33, further comprising a carrier, optionally wherein the carrier is a non-polar hydrocarbon.

39. A dispenser comprising the composition according to claim 33, optionally which allows sustained release of the composition.

40. The dispenser according to claim 39, further comprising a septum, resin or inert polymer beads, granules, pellets or strips, optionally comprising a septum.

41. An apparatus comprising the composition according to claim 33 and a housing for trapping Carpophilus truncatus beetles.

42. The apparatus according to claim 41, further comprising one or more of:
one or more co-attractant compounds;
an insecticide;
a receptacle for containing trapped beetles; and
a lid for the receptacle that allows entry of the beetles into the receptacle.

43. The apparatus according to claim 42, wherein one or both of the following applies:
a. the receptacle for containing trapped beetles is transparent;
b. the lid for the receptacle is green.

44. A kit comprising the composition according to claim 33 and a trapping device, optionally further comprising one or more of:
one or more co-attractant compounds; and
an insecticide.

45. The apparatus according to claim 42, wherein the co-attractant compounds are selected from C₁-C₆ alcohols, C₁-C₄ aldehydes, an indole and C₁-C₁₂ esters, optionally wherein the co-attractant compounds are selected from ethanol, isopentyl alcohol, acetaldehyde, isobutanol, 2-methylbutanol, ethyl acetate, isopentyl acetate, isobutyl acetate, 2-phenylethyl acetate, (E)-4,8-dimethyl-1,3,7-nonatriene (DMNT), methyl benzoate and (Z)-3-hexenyl acetate, optionally wherein the co-attractant compounds are each in separate containers.

46. The apparatus according to claim 42, wherein the co-attractant compounds are present in a mixture, optionally wherein the co-attractant mixture comprises ethanol and isopentyl alcohol.

47. The apparatus according to claim 42, wherein the insecticide is an organophosphate, optionally wherein the insecticide is selected from Dichlorvos, thiometon, naled, parathion, malathion and S-benzyl diisopropyl phosphorothiolate (IBP).

48. A method of attracting or trapping Carpophilus truncatus beetles, said method including the step of exposing a beetle infested environment to the composition according to claim 33; or
a method of monitoring for the presence of Carpophilus truncatus beetles, said method including the step of positioning a composition according to claim 33 within an environment that requires monitoring for the presence of beetles.

49. The method according to claim 48, wherein one of the following applies:
the method is a method of attracting or trapping Carpophilus truncatus beetles and the infested environment is selected from a nut orchard and a nut stockpile; and/or
the method is a method of monitoring for the presence of Carpophilus truncatus beetles and the environment is selected from a nut orchard, a nut stockpile and nuts that are ready for export or have been imported.

50. The method according to claim 49, wherein one of the following applies:
i) the nut orchard is selected from an almond orchard, a pistachio orchard, a walnut orchard, a cashew nut orchard, a kemiri nut orchard, a macadamia nut orchard and a Brazil nut orchard; and/or
ii) the nut in the stockpile or that is ready for export or has been imported is selected from almonds, pistachios, walnuts, cashews, kemiri nuts, macadamia nuts and Brazil nuts.

51. The method according to claim 50, wherein one of the following applies:
i) the nut orchard is selected from an almond orchard, a pistachio orchard and a walnut orchard; and/or
ii) the nut is selected from almonds, pistachios and walnuts.
